(19) United States
(12) Patent Application Publication
(10) Pub. No.: US 2016/0066112 A1
(43) Pub. Date: Mar. 3, 2016

(54) Audio Device, Audio System, and Method

(71) Applicant: YAMAHA CORPORATION, Shizuoka (JP)

(72) Inventors: Akihiko SUYAMA, Hamamatsu-shi (JP); Ryotaro AOKI, Hamamatsu-shi (JP)

(21) Appl. No.: 14/784,669

(22) PCT Filed: Apr. 14, 2014
(86) PCT No.: PCT/JP2014/060598

§ 371 Date: Oct. 15, 2015

(30) Foreign Application Priority Data
Apr. 17, 2013 (JP) 2013-086875

(51) Int. Cl. H04R 29/00; H04S 7/00; H04R 5/02

(52) U.S. Cl. CPC H04R 29/001; H04R 5/02; H04S 7/30; H04R 2205/024

(57) ABSTRACT

An audio device includes: an acquisition unit that acquires first information indicating an arrangement direction of a first loudspeaker, the first information being measured by a terminal device in a state with the terminal device oriented toward the first loudspeaker; and a calculation unit that calculates a position of the first loudspeaker, at least based on a distance from a reference position to the first loudspeaker, and the first information.

### TECHNICAL FIELD

The present invention relates to a device that calculates a position of a loudspeaker.

Priority is claimed on Japanese Patent Application No. 2013-086875 filed on Apr. 17, 2013, the content of which is incorporated herein by reference.

### BACKGROUND ART

An audio device that forms an audio field by a synthetic sound image by using a plurality of loudspeakers has been known. For example, there is an audio source in which multi-channel audio signals such as 5.1 channel signals are recorded, such as a DVD (Digital Versatile Disc). An audio device that reproduces such an audio source has been widely used even in general households. If each loudspeaker is arranged at a recommended position in a listening room, when the audio source is reproduced by using the audio device, a sound reproduction effect such as a surround effect can be acquired. On the other hand, if the arrangement of the loudspeakers is different from the recommended position, the localization of sound may be inadequate. A technique for forming a desired audio field by performing pickup of sound emitted from loudspeakers, by a microphone to calculate a position deviation of the loudspeakers and correcting the sound emitted from the loudspeakers based on the calculation result has been known (for example, refer to Patent Document 1).

### PRIOR ART DOCUMENT

### Patent Document [Patent Document 1] Japanese Unexamined Patent Application, First Publication No. 2000-354300

### SUMMARY OF THE INVENTION

### Problem to be Solved by the Invention

However, in the conventional audio device, four microphones are required in order to specify a three-dimensional position of the loudspeaker. Even if a deviation in a height direction is ignored, in order to specify a two-dimensional position of the loudspeaker, three microphones are required. In either case, there is a problem in that the audio system becomes expensive.

If one microphone is shifted to perform measurement four times or three times, the position of the loudspeaker can be specified by one microphone. However, in this case, time is required for the measurement. Moreover, in order to move the microphone accurately, a seat or the like is required.

The present invention has been conceived in view of the above situation. An example of an object of the present invention is to specify the position of the loudspeaker with a simple configuration.

### Means for Solving the Problem

An audio device according to an aspect of the present invention includes: an acquisition unit that acquires first information indicating an arrangement direction of a first loudspeaker, the first information being measured by a terminal device in a state with the terminal device oriented toward the first loudspeaker; and a calculation unit that calculates a position of the first loudspeaker, at least based on a distance from a reference position to the first loudspeaker, and the first information.

According to the above audio device, the calculation unit calculates the arrangement position of the loudspeaker based on two elements, that is, distance and direction. Therefore, in the case where the distance from the reference position to the loudspeaker is known, the position of the loudspeaker can be specified by only acquiring the arrangement direction of the loudspeaker. Moreover, an audio effect can be added based on a specified position of the loudspeaker. The distance to the loudspeaker can be measured with a simple configuration. Accordingly, even if the loudspeaker is deviated from an ideal position, a desired audio effect can be added with a simple configuration.

The information indicating the arrangement direction of the loudspeaker acquired by the acquisition unit may indicate an arrangement direction as seen from the reference position, being a reference of the distance, or may indicate an arrangement direction as seen from an arbitrary position. When the information indicates the arrangement direction as seen from an arbitrary position, the acquisition unit may acquire the arrangement direction of the loudspeaker as seen from the arbitrary position, and a relative position between the arbitrary position and the reference position. Moreover, the calculation unit may calculate the position of the loudspeaker, based on a relative position, the arrangement direction of the loudspeaker as seen from an arbitrary position and the distance between the loudspeaker and the reference position. More specifically, the calculation unit may convert the information indicating the arrangement direction of the loudspeaker as seen from an arbitrary position into information indicating the arrangement direction of the loudspeaker as seen from the reference position. Furthermore, the calculation unit may calculate the position of the loudspeaker based on a conversion result and the distance between the loudspeaker and the reference position.

An audio system according to an aspect of the present invention includes: a direction measurement unit that measures first information indicating an arrangement direction of a first loudspeaker in a state with a terminal device oriented toward the first loudspeaker; and a calculation unit that calculates a position of the first loudspeaker, at least based on a distance from a reference position to the first loudspeaker, and the first information.

The distance to the loudspeaker can be measured with a simple configuration. According to the above audio system, the calculation unit calculates a position of the loudspeaker based on two elements, that is, distance and direction. Therefore, even if the loudspeaker is deviated from an ideal position, a desired audio effect can be added with a simple configuration.

A method for an audio system according to an aspect of the present invention includes: measuring first information indicating an arrangement direction of a first loudspeaker in a state with a terminal device oriented toward the first loudspeaker; and calculating a position of the first loudspeaker, at least based on a distance from a reference position to the first loudspeaker, and the first information.

### BRIEF DESCRIPTION OF THE DRAWINGS

FIG. 1 is a block diagram showing a configuration example of an audio system, according to an embodiment of the present invention.

FIG. 2 is a plan view showing arrangement of loudspeakers in a listening room, in the present embodiment.

FIG. 3 is a block diagram showing an example of a hardware configuration of a terminal device, according to the present embodiment.

FIG. 4 is a diagram for explaining an angle measured by a gyro sensor, according to the present embodiment.

FIG. 5 is a block diagram showing an example of a hardware configuration of an audio device, according to the present embodiment.

FIG. 6 is a plan view showing an arrangement of a microphone at the time of measuring a distance to the loudspeaker, in the present embodiment.

FIG. 7 is a flowchart showing the content of a measurement process of a distance between a plurality of loudspeakers and a reference position, in the present embodiment.

FIG. 8 is a diagram for explaining a position of the loudspeaker determined by a measurement result of the distance, in the present embodiment.

FIG. 9 is a flowchart showing processing details of a direction measurement process, in the present embodiment.

FIG. 10 is a diagram for explaining an example of an image to be displayed on a display unit in the direction measurement process, in the present embodiment.

FIG. 11 is a diagram for explaining an example of an image to be displayed on the display unit in the direction measurement process, in the present embodiment.

FIG. 12 is a diagram for explaining an example of calculating a position of the loudspeaker, in the present embodiment.

FIG. 13 is a flowchart showing the content of a designation process for a position of a virtual sound source, in the present embodiment.

FIG. 14 is a diagram for explaining an example of an image to be displayed on the display unit in the designation process for the position of the virtual sound source, in the present embodiment.

FIG. 15A is a diagram for explaining an example of an image to be displayed on the display unit in the designation process for the position of the virtual sound source, in the present embodiment.

FIG. 15B is a diagram for explaining an example of an image to be displayed on the display unit in the designation process for the position of the virtual sound source, in the present embodiment.

FIG. 16 is a functional block diagram showing a functional configuration of the audio system, according to the present embodiment.

FIG. 17 is a functional block diagram showing a functional configuration of an audio system, according to a first modification example of the present embodiment.

FIG. 18 is a diagram for explaining a method of converting an angle of the loudspeaker as seen from an arbitrary position into an angle as seen from the reference position, in a third modification example of the present embodiment.

FIG. 19 is a perspective view showing an example in which loudspeakers are arranged three-dimensionally, in a fifth modification example of the present embodiment.

### EMBODIMENTS FOR CARRYING OUT THE INVENTION

Hereunder, embodiments of the present invention will be described with reference to the drawings.

### <Configuration of the Audio System>

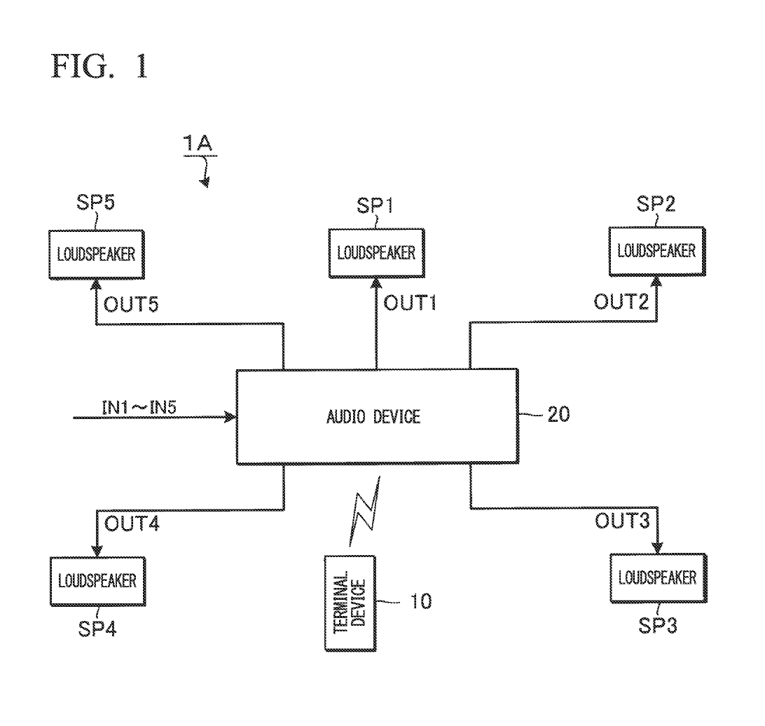

FIG. 1 shows a configuration example of an audio system 1A according to a first embodiment of the present invention. The audio system 1A includes a terminal device 10, an audio device 20, and a plurality of loudspeakers SP1 to SP5. The terminal device 10 may be a communication device, for example, a smartphone. The terminal device 10 is communicable with the audio device 20. The terminal device 10 and the audio device 20 can perform communication via a wireless or wired network. For example, the terminal device 10 and the audio device 20 may communicate with each other via a wireless LAN (Local Area Network). The terminal device 10 can download an application program from a predetermined website on the Internet. The application program includes a program to be used for measuring respective directions of the loudspeakers SP1 to SP5.

The audio device 20 may be a so-called multichannel amplifier. The audio device 20 generates output audio signals OUT1 to OUT5 in which an audio effect is added to input audio signals IN1 to IN5, and supplies the output audio signals OUT1 to OUT5 to the loudspeakers SP1 to SP5. The loudspeakers SP1 to SP5 are connected to the audio device 20 via a wired or wireless network.

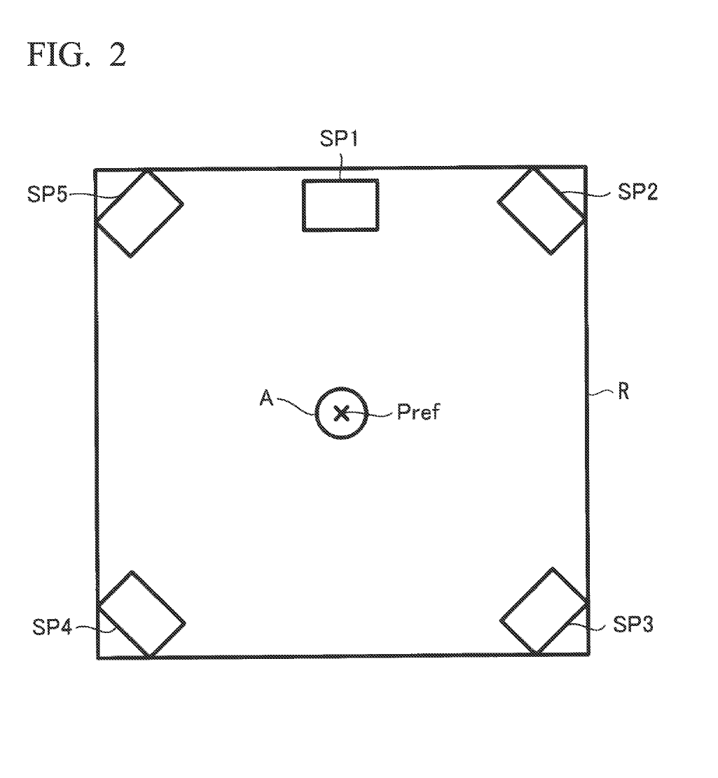

FIG. 2 shows an arrangement example of the loudspeakers SP1 to SP5 in a listening room R of the audio system 1A. In the example, 5 loudspeakers SP1 to SP5 are arranged in the listening room R. However, the number of loudspeakers is not limited to 5, and may be 4 or less, or 6 or more. Similarly, the number of the input audio signals may be 4 or less, or 6 or more. For example, the audio system 1A may be a so-called 5.1 surround system including a subwoofer loudspeaker.

A user A listens to the sound emitted from the loudspeakers SP1 to SP5 at a predetermined position (hereinafter, referred to as “reference position”) Pref. In the example, the loudspeaker SP1 is arranged at the front of the user A. The loudspeaker SP2 is arranged diagonally right forward of the user A. The loudspeaker SP3 is arranged diagonally right rearward of the user A. The loudspeaker SP4 is arranged diagonally left rearward of the user A. The loudspeaker SP5 is arranged diagonally left forward of the user A. The user A simultaneously listens to the sounds emitted from the loudspeakers SP1 to SP5, thereby having a feeling that there is a sound source at a specific position.

The audio device 20 generates the output audio signals OUT1 to OUT5 that sound as if the sound is coming from a desired position, based on the arrangement positions of the plurality of loudspeakers SP1 to SP5. The audio device 20 then outputs the generated output audio signals OUT1 to OUT5. The respective positions of the loudspeakers SP1 to SP5 are measured beforehand.

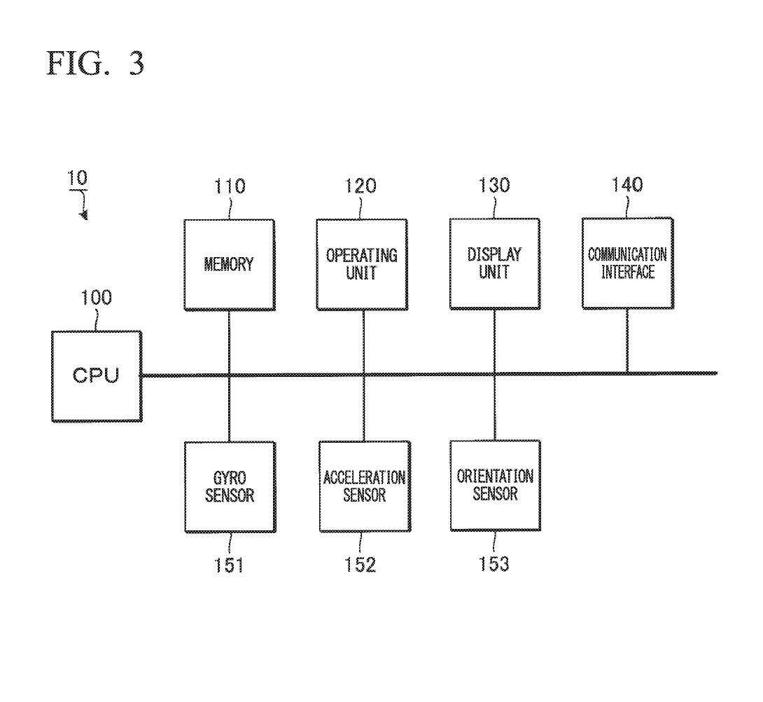

FIG. 3 shows an example of a hardware configuration of the terminal device 10. In the example shown in FIG. 3, the terminal device 10 includes a CPU 100, a memory 110, an operating unit 120, a display unit 130, a communication interface 140, a gyro sensor 151, an acceleration sensor 152, and an orientation sensor 153. The CPU 100 functions as a control center of the entire device. The memory 110 memorizes a program such as an application program, and functions as a work area of the CPU 100. The operating unit 120 receives an input of an instruction from a user. The display unit 130 displays operation details and the like. The communication interface 140 performs communication with outside.

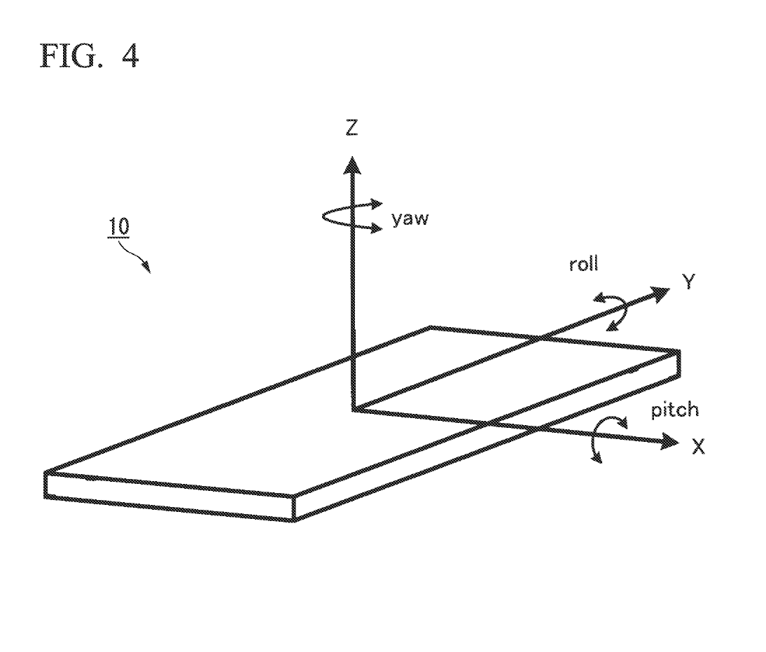

In the example shown in FIG. 4, the X axis corresponds to a width direction of the terminal device 10. The Y axis corresponds to a height direction of the terminal device 10. The Z axis corresponds to a thickness direction of the terminal device 10. The X axis, the Y axis, and the Z axis are orthogonal to each other. A pitch angle (pitch), a roll angle (roll), and a yaw angle (yaw) are respectively rotation angles around the X axis, the Y axis, and the Z axis. The gyro sensor 151 detects and outputs the pitch angle, the roll angle, and the yaw angle of the terminal device 10. An orientation direction of the terminal device 10 can be specified based on these rotation angles. The acceleration sensor 152 measures an X-axis, a Y-axis, and a Z-axis direction component of acceleration added to the terminal device 10. In this case, acceleration measured by the acceleration sensor 152 is represented by three-dimensional vectors. The direction in which the terminal device 10 faces can be specified based on the three-dimensional vectors. The orientation sensor 153 detects, for example, geomagnetism to thereby measure the orientation in which the orientation sensor 153 faces. The direction in which the terminal device 10 faces can be specified based on this orientation. Signals output by the gyro sensor 151 and the acceleration sensor 152 are in a triaxial coordinate system provided in the terminal device 10, and are not in a coordinate system fixed to the listening room. As a result, the direction measured by the gyro sensor 151 and the acceleration sensor 152 is relative orientation. That is to say, when the gyro sensor 151 or the acceleration sensor 152 is used, an arbitrary target fixed in the listening room is used as a reference, and an angle with respect to the reference is acquired as a relative direction. On the other hand, the signal output by the orientation sensor 153 is the orientation on the earth, and indicates an absolute direction.

The CPU 100 executes the application program to measure the direction in which the terminal device 10 faces by using at least one of outputs of the gyro sensor 151, the acceleration sensor 152, and the orientation sensor 153. In the example shown in FIG. 3, the terminal device 10 includes the gyro sensor 151, the acceleration sensor 152, and the orientation sensor 153. However, it is not limited to such a configuration. The terminal device 10 may include only one of the gyro sensor 151, the acceleration sensor 152, and the orientation sensor 153. The gyro sensor 151 and the acceleration sensor 152 output angles. The angle is indicated by a value with respect to an arbitrary reference. A target to be the reference may be selected arbitrarily from objects in the listening room. As a specific example, a case where a loudspeaker whose direction is measured first, of the loudspeakers SP1 to SP5, is selected as the target will be described later.

On the other hand, in the case where the directions of the loudspeakers SP1 to SP5 are measured by using the orientation sensor 153, an input of the reference direction is not required. The reason for this is that the orientation sensor 153 outputs a value indicating the absolute direction.

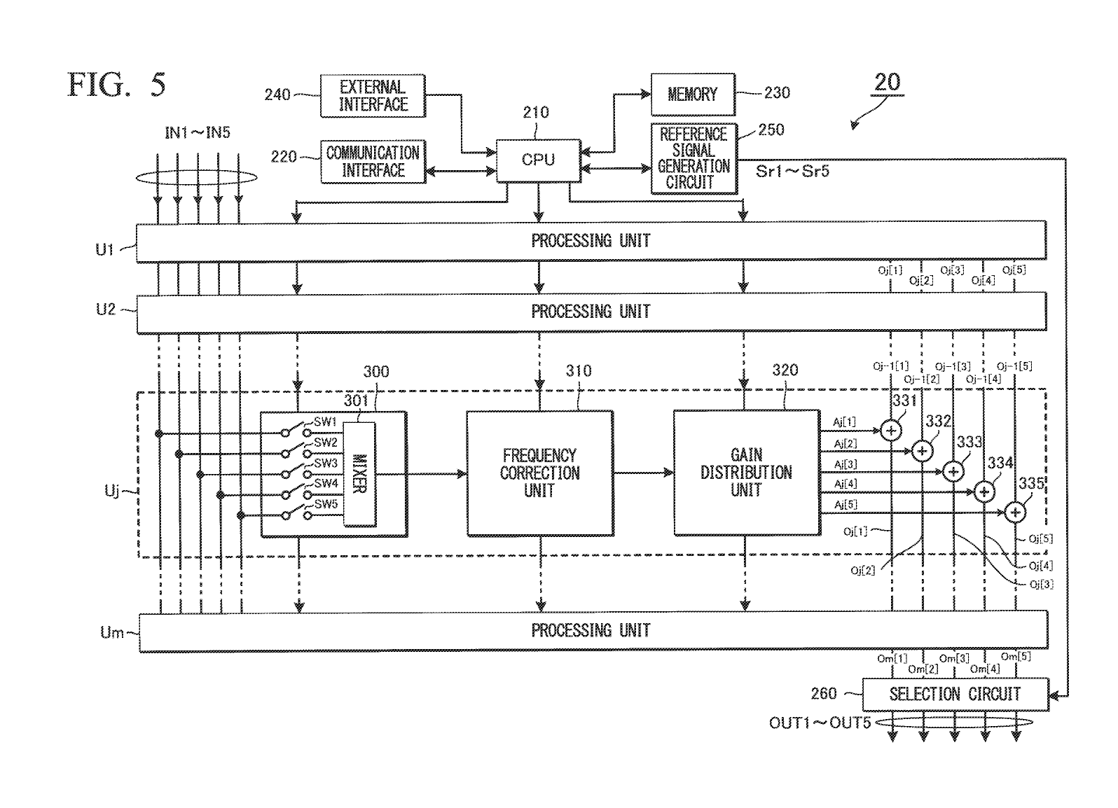

In the example shown in FIG. 5, the audio device 20 includes a CPU 210, a communication interface 220, a memory 230, an external interface 240, a reference signal generation circuit 250, a selection circuit 260, and m processing units U1 to Um. The CPU 210 functions as a control center of the entire device. The communication interface 220 executes communication with the outside. The memory 230 memorizes a program and data, or functions as a work area of the CPU 210. The external interface 240 receives an input of a signal from an external device such as a microphone, and supplies the signal to the CPU 210. The reference signal generation circuit 250 generates reference signals Sr1 to Sr5. The processing units U1 to Um and the CPU210 generate output audio signals OUT1 to OUT5, in which an audio effect is added to input audio signals IN1 to IN5, based on the respective positions of the loudspeakers SP1 to SP5. The output audio signals OUT1 to OUT5 are respectively supplied to the loudspeakers SP1 to SP5.

The j-th processing unit Uj includes a virtual sound source generation unit (hereinafter, simply referred to as “conversion unit”) 300, a frequency correction unit 310, a gain distribution unit 320, and adders 331 to 335 (“j” is an arbitrary natural number satisfying 1≦j≦m). The processing units U1, U2, and so forth, Uj−1, Uj+1, and so forth, and Um are configured to be the same as the processing unit Uj.

The conversion unit 300 generates an audio signal of a virtual sound source, based on the input audio signals IN1 to IN5. In the example, because m processing units U1 to Um are provided, the output audio signals OUT1 to OUT5 corresponding to m virtual sound sources can be generated. The conversion unit 300 includes 5 switches SW1 to SW5, and a mixer 301. The CPU 210 controls the conversion unit 300. More specifically, the CPU 210 memorizes a virtual sound source management table for managing m virtual sound sources in the memory 230, and controls the conversion unit 300, by referring to the virtual sound source management table. Reference data representing which input audio signals IN1 to IN5 need to be mixed for the respective virtual sound sources, is stored in the virtual sound source management table. The reference data may be, for example, a channel identifier indicating a channel to be mixed, or a logical value representing whether to perform mixing for each channel. The CPU 210 refers to the virtual sound source management table to sequentially turn on the switches corresponding to the input audio signal to be mixed, of the input audio signals IN1 to IN5, and fetches the input audio signals to be mixed. As a specific example, a case where the input audio signals to be mixed are the input audio signals IN1, IN2, and IN5 is described here. In this case, the CPU 210 switches on the switch SW1 corresponding to the input audio signal IN1, and switches off the other switches SW2 to SW5. Next, the CPU 210 switches on the switch SW2 corresponding to the input audio signal IN2, and switches off the other switches SW1, and SW3 to SW5. Then, the CPU 210 switches on the switch SW5 corresponding to the input audio signal IN5, and switches off the other switches SW1 to SW4.

The frequency correction unit 310 performs frequency correction on an output signal of the conversion unit 300. Specifically, under control of the CPU 210, the frequency correction unit 310 corrects a frequency characteristic of the output signal according to a distance from the position of the virtual sound source to the reference position Pref. More specifically, the CPU 210 corrects the frequency characteristic of the output signal such that high-pass frequency components are largely attenuated, as the distance from the position of the virtual sound source to the reference position Pref increases. This is for reproducing acoustic characteristics such that an attenuation amount of the high frequency components increases, as the distance from the virtual sound source to the reference position Pref increases.

The memory 230 memorizes an attenuation amount table beforehand. In the attenuation amount table, data representing a relation between the distance from the virtual sound source to the reference position Pref, and the attenuation amount of the respective frequency components is stored. In the virtual sound source management table, data representing the positions of the respective virtual sound sources is stored. The position of the virtual sound source is represented by, for example, three-dimensional orthogonal coordinates, two-dimensional orthogonal coordinates, or polar coordinates, with the reference position Pref as the origin.

The CPU 210 executes first to third processes described below. As a first process, the CPU 210 reads a content of the virtual sound source management table memorized in the memory 230. Further, the CPU 210 calculates the distance from the respective virtual sound sources to the reference position Pref, based on the read content of the virtual sound source management table. As a second process, the CPU 210 refers to the attenuation amount table to acquire the attenuation amounts of the respective frequencies according to the calculated distance to the reference position Pref. As a third process, the CPU 210 controls the frequency correction unit 310 so that the frequency characteristic corresponding to the acquired attenuation amount can be acquired.

Under control of the CPU 210, the gain distribution unit 320 distributes the output signal of the frequency correction unit 310 to a plurality of audio signals Aj[1] to Aj[5] for the loudspeakers SP1 to SP5. At this time, the gain distribution unit 320 amplifies the output signal of the frequency correction unit 310 at a predetermined ratio for each of the audio signals Aj[1] to Aj[5]. The size of the gain of the audio signal with respect to the output signal decreases, as the distances between the respective loudspeakers SP1 to SP5 and the virtual sound source increases. According to such a process, a sound field as if sound is emitted from a place set as the position of the virtual sound source can be formed.

For example, the size of the gain of the respective audio signals Aj[1] to Aj[5] may be proportional to a reciprocal of the distances between the respective loudspeakers SP1 to SP5 and the virtual sound source. As another method, the size of the gain may be set so as to be proportional to a reciprocal of the square or the fourth power of the distances between the respective loudspeakers SP1 to SP5 and the virtual sound source. If the distance between any of the loudspeakers SP1 to SP5 and the virtual sound source is substantially 0, the gain of the audio signals Aj[1] to Aj[5] with respect to the other loudspeakers SP1 to SP5 may be set to 0.

The memory 230 memorizes, for example, a loudspeaker management table. In the loudspeaker management table, data indicating the respective positions of the loudspeakers SP1 to SP5 and data indicating the distances between the respective loudspeakers SP1 to SP5 and the reference position Pref are stored in a state of being associated with identifiers of the respective loudspeakers SP1 to SP5. The positions of the loudspeakers SP1 to SP5 are represented by, for example, three-dimensional orthogonal coordinates or polar coordinates, with the reference position Pref as the origin.

As the first process, the CPU 210 refers to the virtual sound source management table and the loudspeaker management table stored in the memory 230, and calculates the distances between the respective loudspeakers SP1 to SP5 and the respective virtual sound sources. As the second process, the CPU 210 calculates the gain of the audio signals Aj[1] to Aj[5] with respect to the respective loudspeakers SP1 to SP5 based on the calculated distance, and supplies a control signal designating the gain to the respective processing units U1 to Um.

The adders 331 to 335 of the processing unit Uj add the audio signals Aj[1] to Aj[5] output from the gain distribution unit 320 and audio signals Oj-1[1] to Oj-1[5] supplied from the processing unit Uj-1 in the previous stage, and output audio signals Oj[1] to Oj[5]. As a result, an audio signal Om[k] output from the processing unit Um becomes Om[k]=A1[k]+A2[k]+ . . . +Aj[k]+ . . . +Am[k] (“k” is an arbitrary natural number from 1 to 5).

Under control of the CPU 210, the reference signal generation circuit 250 generates the reference signals Sr1 to Sr5 to be used for the measurement of the distances between the loudspeakers SP1 to SP5 and the reference position Pref (a microphone M), and outputs the reference signals to the selection circuit 260. At the time of measurement of the distances between loudspeakers SP1 to SP5 and the position Pref, the CPU 210 causes the reference signal generation circuit 250 to generate the reference signals Sr1 to Sr5. When the distances to the plurality of loudspeakers SP1 to SP5 are to be measured respectively, the CPU 210 controls the selection circuit 260 to select the reference signals Sr1 to Sr5, and supply them to the loudspeakers SP1 to SP5 respectively. At the time of adding the audio effect, the CPU 210 controls the selection circuit 260 to select the audio signals Om[1] to Om[5], and supply them to the loudspeakers SP1 to SP5 respectively.

<Operation of the Audio System>

Next, an operation of the audio system will be described by dividing the operation into specification of the position of the loudspeaker and designation of the position of the virtual sound source.

<Specification Process for the Position of the Loudspeaker>

At the time of specifying the position of the loudspeaker, first to third processes are executed. As the first process, the distances between the respective loudspeakers SP1 to SP5 and the reference position Pref are measured. As the second process, the direction in which the respective loudspeakers SP1 to SP5 are arranged is measured. As the third process, the respective positions of the loudspeakers SP1 to SP5 are specified based on the measured distance and direction.

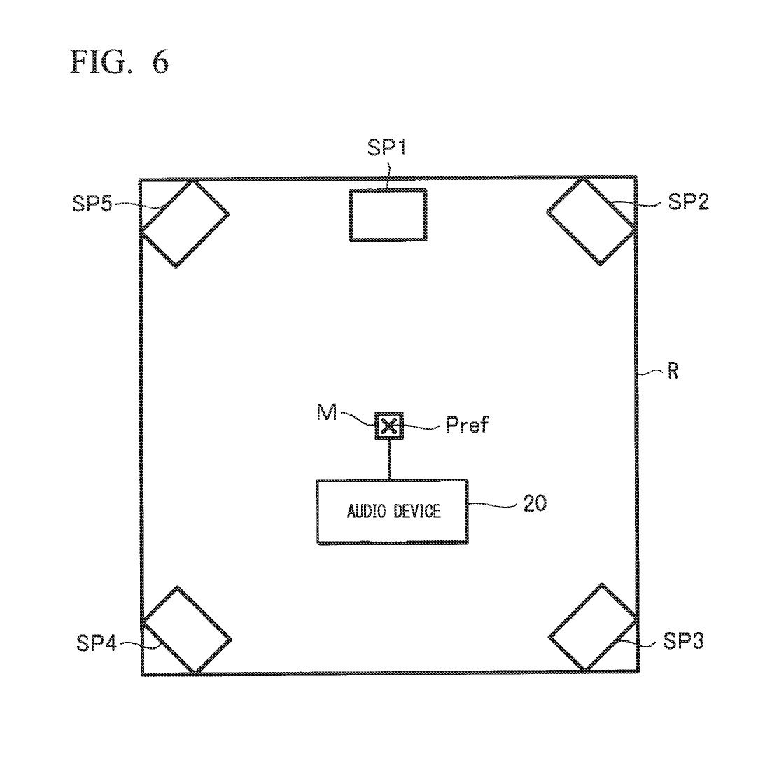

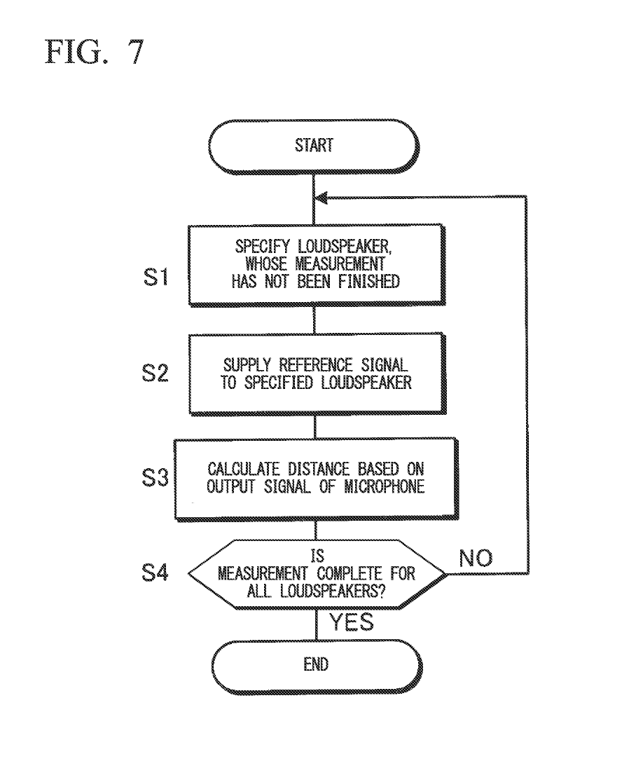

In the measurement of the distance, as shown in FIG. 6, the microphone M is arranged at the reference position Pref, and the microphone M is connected to the audio device 20. The output signal of the microphone M is supplied to the CPU 210 via the external interface 240. FIG. 7 shows the content of a measurement process for the distances between the loudspeakers SP1 to SP5 and the reference position Pref, to be executed by the CPU 210 of the audio device 20.

(Step S1)

The CPU 210 specifies one loudspeaker, for which measurement has not been finished, as the loudspeaker to be measured. For example, if measurement of the distance between the loudspeaker SP1 and the reference position Pref has not been performed, the CPU 210 specifies the loudspeaker SP1 as the loudspeaker to be measured.

(Step S2)

The CPU 210 controls the reference signal generation circuit 250 so as to generate the reference signal corresponding to the loudspeaker to be measured, of the reference signals Sr1 to Sr5. Moreover, the CPU 210 controls the selection circuit 260 so that the generated reference signal is supplied to the loudspeaker to be measured. At this time, the generated reference signal is output as one of the output audio signals OUT1 to OUT5 corresponding to the loudspeaker to be measured. For example, the CPU 210 controls the selection circuit 260 so that the generated reference signal Sr1 is output as the output audio signal OUT1 corresponding to the loudspeaker SP1 to be measured.

(Step S3)

The CPU 210 calculates the distance between the loudspeaker to be measured and the reference position Pref, based on the output signal of the microphone M. Moreover, the CPU 210 records the calculated distance in the loudspeaker management table, in association with the identifier of the loudspeaker to be measured.

(Step S4)

The CPU 210 determines whether measurement of all the loudspeakers is complete. If there is a loudspeaker whose measurement has not been finished (step S4: NO), the CPU 210 returns the process to step 51, and repeats the process from step S1 to step S4 until measurement of all the loudspeakers is complete. If measurement of all the loudspeakers is complete (step S4: YES), the CPU 210 finishes the process.

According to the above process, the distances from the reference position Pref to loudspeakers SP1 to SP5 are measured.

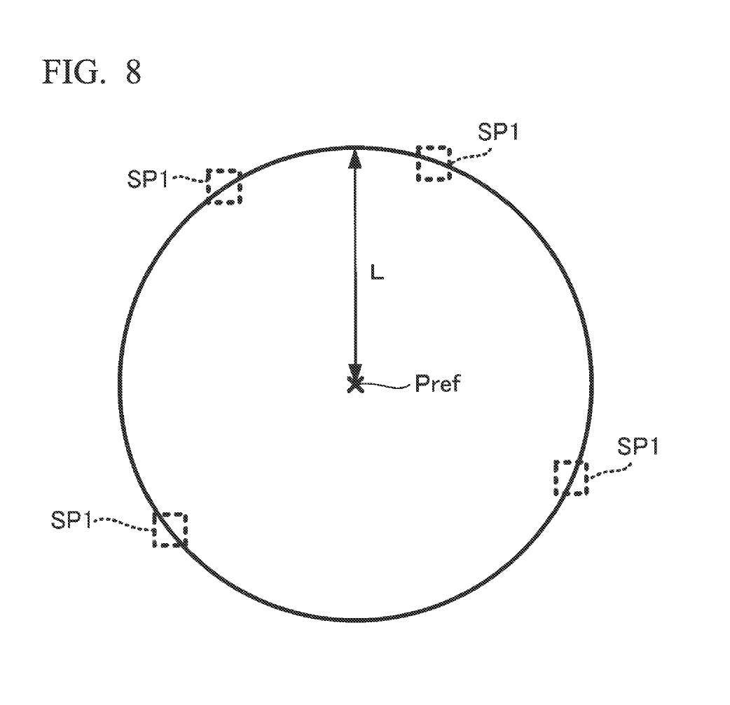

For example, it is assumed that the distance from the reference position Pref to the loudspeaker SP1 is “L”. In this case, as shown in FIG. 8, it is seen that the loudspeaker SP1 is on a circle having a radius L from the reference position Pref. However, it is not specified at which position on the circle the loudspeaker SP1 is. Therefore, in the present embodiment the direction of the loudspeaker SP1 as seen from the reference position Pref is measured by using the terminal device 10 to specify the position of the loudspeaker SP1.

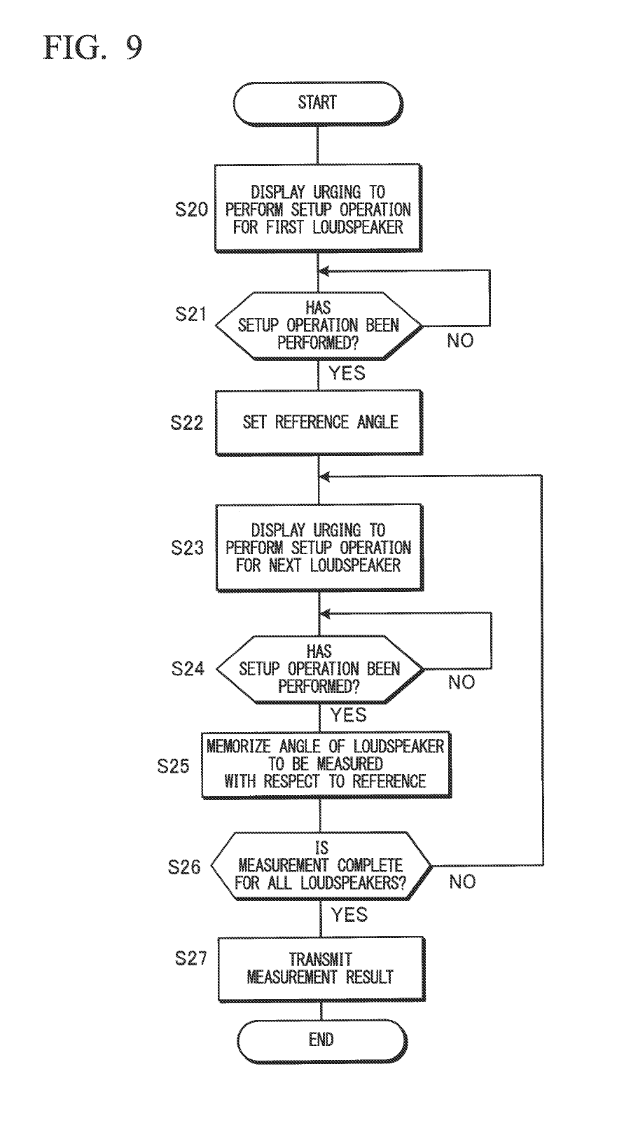

FIG. 9 shows the content of a direction measurement process executed by the CPU 100 of the terminal device 10. In the example, the respective directions of loudspeakers SP1 to SP5 are specified by using at least one of the gyro sensor 151 and the acceleration sensor 152. As described above, the gyro sensor 151 and the acceleration sensor 152 output the angle. In the example, the reference of the angle is the loudspeaker whose arrangement direction is measured first.

(Step S20)

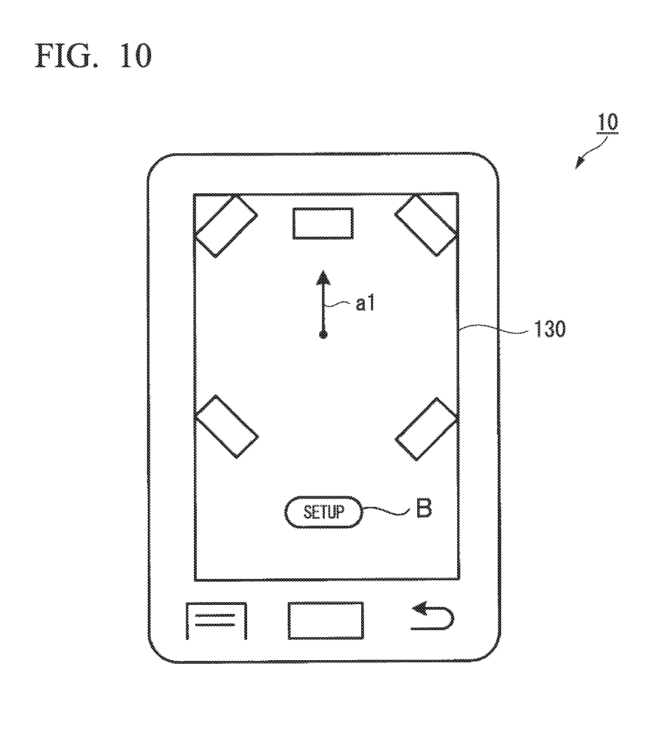

Upon startup of the application of the direction measurement process, the CPU 100 causes the display unit 130 to display an image urging the user to perform a setup operation in a state with the terminal device 10 oriented toward the first loudspeaker. For example, if the arrangement direction of the loudspeaker SP1 is set first, as shown in FIG. 10, the CPU 100 displays an arrow al oriented toward the loudspeaker SP1 on the display unit 130.

(Step S21)

The CPU 100 determines whether the setup operation has been performed by the user. Specifically, the CPU 100 determines whether the user has pressed a setup button B (a part of the above-described operating unit 120) shown in FIG. 10. If the setup operation has not been performed, the CPU 100 repeats determination until the setup operation is performed.

(Step S22)

If the setup operation is performed, the CPU 100 sets the measurement angle measured by the gyro sensor 151 or the acceleration sensor 152 at the time of operation as the angle to be the reference. That is to say, the CPU 100 sets the direction from the reference position Pref toward the loudspeaker SP1 to 0 degree.

(Step S23)

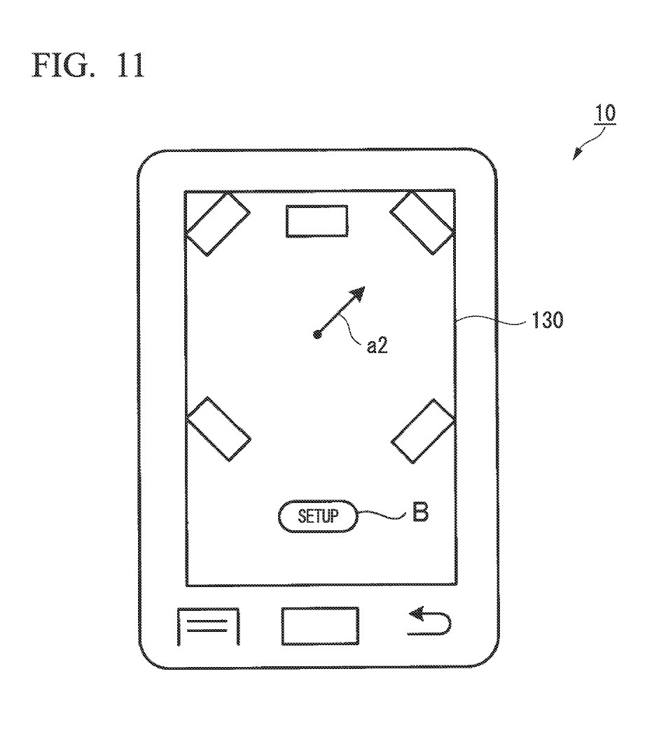

The CPU 100 causes the display unit 130 to display an image urging the user to perform the setup operation in a state with the terminal device 10 oriented toward the next loudspeaker. For example, if the arrangement direction of the loudspeaker SP2 is set in the second place, as shown in FIG. 11, the CPU 100 displays an arrow a2 oriented toward the loudspeaker SP2 on the display unit 130.

(Step S24)

The CPU 100 determines whether the setup operation has been performed by the user. Specifically, the CPU 100 determines whether the user has pressed the setup button shown in FIG. 11. If the setup operation has not been performed, the CPU 100 repeats determination until the setup operation is performed.

(Step S25)

If the setup operation is performed, the CPU 100 uses the output value of the gyro sensor 151 or the acceleration sensor 152 at the time of operation to memorize the angle of the loudspeaker to be measured with respect to the reference, in the memory 110.

(Step S26)

The CPU 100 determines whether measurement is complete for all the loudspeakers. If there is a loudspeaker whose measurement has not been finished (step S26: NO), the CPU 100 returns the process to step S23, and repeats the process from step S23 to step S26 until measurement is complete for all the loudspeakers.

(Step S27)

If measurement of the direction is complete for all the loudspeakers, the CPU 100 transmits a measurement result to the audio device 20 by using the communication interface 140.

According to the above process, the directions in which the loudspeakers SP1 to SP5 are respectively arranged are measured. In the above-described example, the measurement results are collectively transmitted to the audio device 20. However, the transmission method is not limited to such a process. The CPU 100 may transmit the measurement result to the audio device 20 every time the arrangement direction of one loudspeaker is measured. As described above, the arrangement direction of the loudspeaker SP1 to be measured first is used as the reference of the angle of the other loudspeakers SP2 to SP5. The angle relating to the loudspeaker SP1 is 0 degree. Therefore, transmission of the measurement result relating to the loudspeaker SP1 may be omitted.

Thus, in the case where the respective arrangement directions of the loudspeakers SP1 to SP5 are specified by using the angle with respect to the reference, the load on the user can be reduced by setting the reference to one of the loudspeakers SP1 to SP5.

A case where the reference of the angle does not correspond to any of the loudspeakers SP1 to SP5, and the reference of the angle is an arbitrary target arranged in the listening room will be described here. In this case, the user orients the terminal device 10 to the target, and performs setup of the reference angle by performing a predetermined operation in this state. Further, the user performs a predetermined operation in a state with the terminal device 10 oriented toward each of the loudspeakers SP1 to SP5, thereby designating the direction.

Accordingly, if the reference of the angle is the arbitrary target arranged in the listening room, an operation to be performed in the state with the terminal device 10 oriented toward the target is required additionally. On the other hand, by setting the target to any one of the loudspeakers SP1 to SP5, the input operation can be simplified.

The CPU 210 of the audio device 20 acquires the (information indicating) arrangement direction of each of the loudspeakers SP1 to SP5 by using the communication interface 220. The CPU 210 calculates the respective positions of the loudspeakers SP1 to SP5 based on the arrangement direction and the distance of each of the loudspeakers SP1 to SP5. That is to say, the CPU 210 and the communication interface 220 function as an acquisition unit that acquires the arrangement directions of the respective loudspeakers SP1 to SP5.

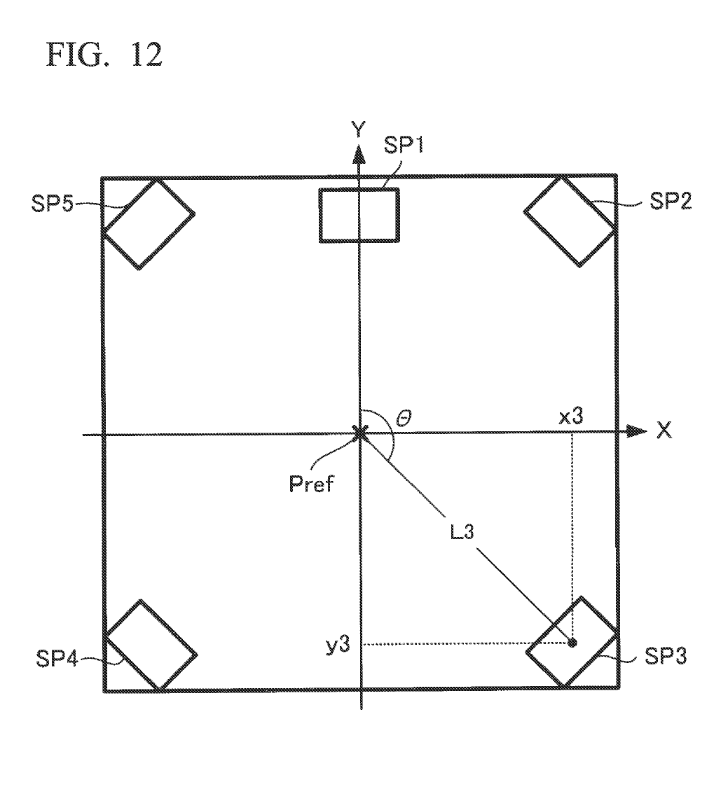

As a specific example, as shown in FIG. 12, a case where the arrangement direction of the loudspeaker SP3 is an angle θ, and the distance to the loudspeaker SP3 is L3 will be described. In this case, the CPU 210 calculates the coordinates (x3, y3) of the loudspeaker SP3 according to equation (A) shown below.

(x3,y3)=(L3 sin θ,L3 cos θ) Equation (A)

It also calculates the coordinates (x, y) for the other loudspeakers SP1, SP2, SP4, and SP5 in a similar manner.

The CPU 210 calculates the respective positions of the loudspeakers SP1 to SP5 based on the distance from the reference position Pref to the respective loudspeakers SP1 to SP5, and the arrangement direction of the respective loudspeakers SP1 to SP5.

<Designation Process for the Position of the Virtual Sound Source>

Next, the designation process for the position of the virtual sound source is described. In the present embodiment, designation of the position of the virtual sound source is performed by using the terminal device 10.

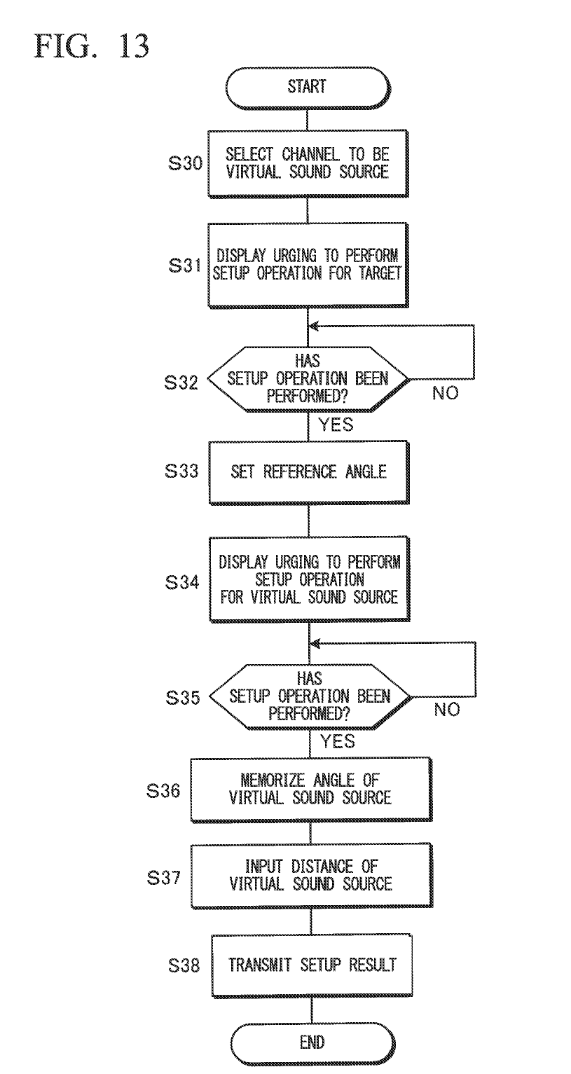

FIG. 13 shows the content of the designation process for the position of the virtual sound source executed by the CPU 100 of the terminal device 10.

(Step S30)

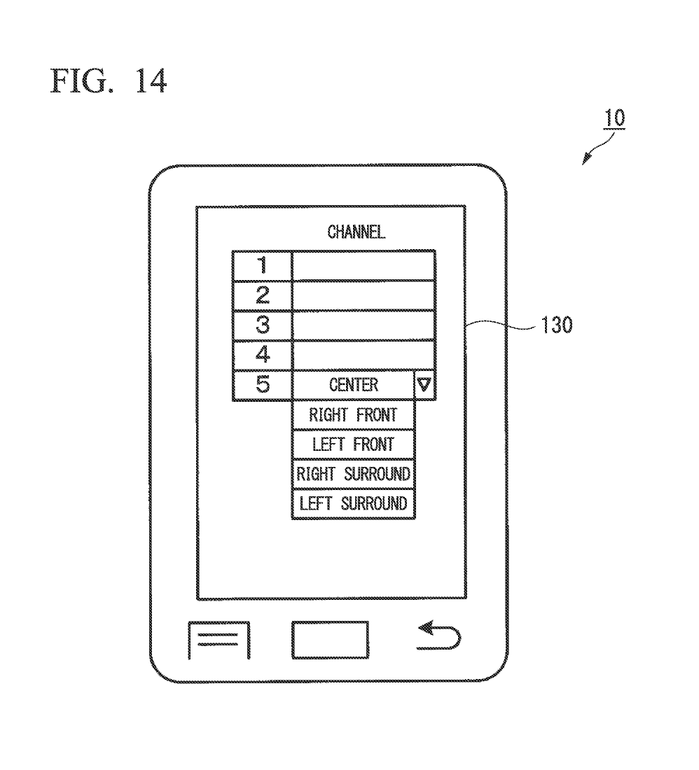

The CPU 100 causes the display unit 130 to display an image urging the user to select a channel to be a virtual sound source, and acquires the number of the channel selected by the user. For example, the CPU 100 causes the display unit 130 to display the screen shown in FIG. 14. In the example, the number of virtual sound sources is 5. Numbers of “1” to “5” are allocated to each of the virtual sound sources. The channel can be selected by a pull-down menu. In FIG. 14, the channel corresponding to virtual sound source number 5 is displayed in the pull-down menu. The channel includes center, right front, left front, right surround, and left surround. When the user selects an arbitrary channel from the pull-down menu, the CPU 100 acquires the selected channel.

(Step S31)

The CPU 100 causes the display unit 130 to display an image urging the user to perform the setup operation in a state with the terminal device oriented toward the target. It is desired that the target agrees with the target used as the reference of the angle of the loudspeaker in the specification process for the position of the loudspeaker. Specifically, it is desired to set the target to the loudspeaker SP1 to be set first. In this case, the CPU 100 causes the display unit 130 to display the screen shown in FIG. 10 to urge the user to perform the setup operation.

(Step S32)

The CPU 100 determines whether the setup operation has been performed by the user. Specifically, the CPU 100 determines whether the user has pressed the setup button B shown in FIG. 10. If the setup operation has not been performed, the CPU 100 repeats the determination until the setup operation is performed.

(Step S33)

If the setup operation is performed, the CPU 100 sets the measurement angle measured by the gyro sensor 151 and the like at the time of operation, as the angle to be the reference. That is to say, the CPU 100 sets the direction from the reference position Pref toward the loudspeaker SP1 (target) to 0 degree.

(Step S34)

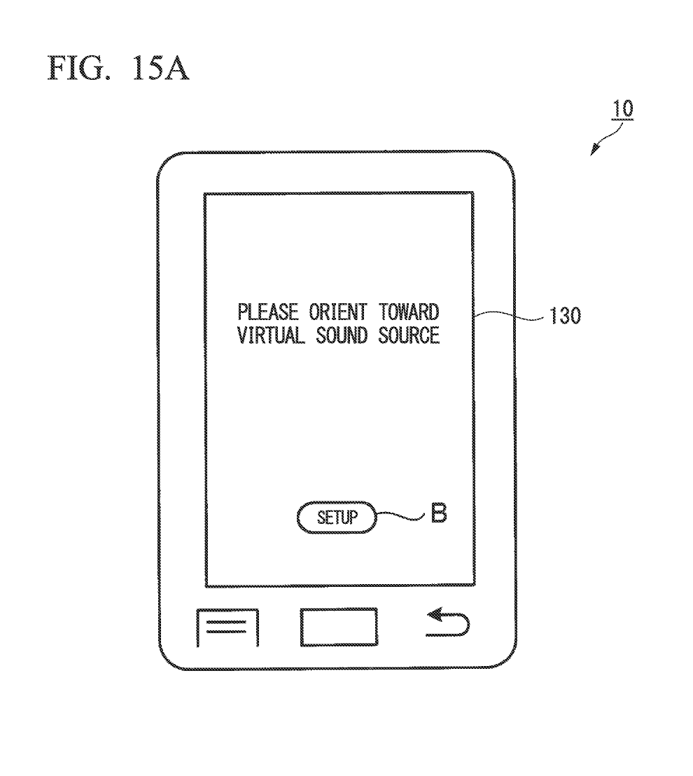

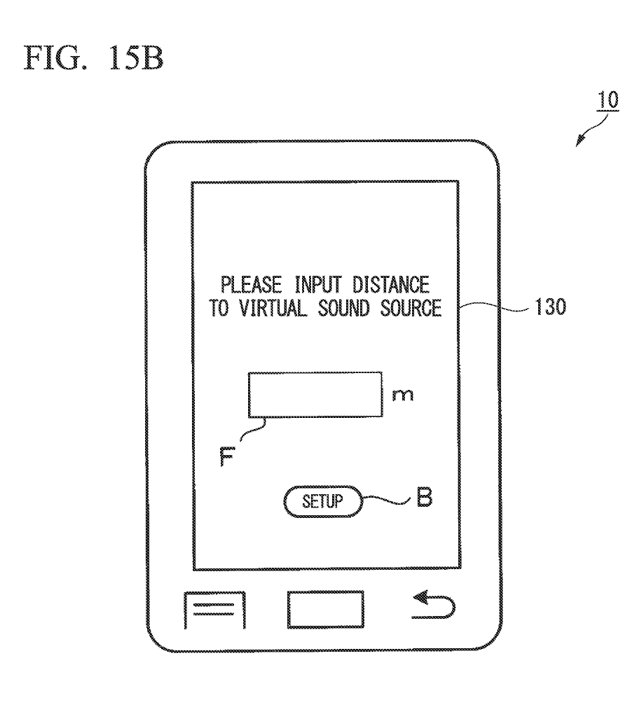

The CPU 100 causes the display unit 130 to display an image urging the user to perform the setup operation in a state with the terminal device oriented toward the direction in which the user desires to arrange the virtual sound source. For example, the CPU 100 displays the screen shown in FIG. 15A on the display unit 130.

(Step S35)

The CPU 100 determines whether the user has performed the setup operation. Specifically, the CPU 100 determines whether the user has pressed the setup button B shown in FIG. 15A. If the setup operation has not been performed, the CPU 100 repeats the determination until the setup operation is performed.

(Step S36)

If the setup operation is performed, the angle of the virtual sound source with respect to the reference is memorized in the memory 110 by using an output value of the gyro sensor 151 or the like at the time of operation.

(Step S37)

The CPU 100 receives an input of the distance from the virtual sound source to the reference position Pref. For example, the CPU 100 causes the display unit 130 to display the screen shown in FIG. 15B to urge the user to input the distance to the virtual sound source. If the user inputs the distance in an input box F and presses the setup button B, the CPU 100 acquires the distance input as the distance from the reference position Pref to the virtual sound source.

(Step S38)

The CPU 100 transmits to the audio device 20, the (information indicating) arrangement direction of the virtual sound source and the distance to the virtual sound source, as a setup result.

The CPU 210 of the audio device 20 receives the setup result by using the communication interface 220. The CPU 210 calculates the position of the virtual sound source by using the same method as that for calculating the absolute position of the loudspeaker based on the direction and the distance of the loudspeaker. The CPU 210 controls the processing units U1 to Um based on the position of the virtual sound source and the positions of the loudspeakers SP1 to SP5, so that sound is heard from the position of the virtual sound source. As a result, the output audio signals OUT1 to OUT5 obtained by performing sound processing such that the sound of the designated channel is heard from the position of the virtual sound source, are generated by using the terminal device 10. In the example, the arrangement direction of the virtual sound source and the distance to the virtual sound source, are transmitted from the terminal device 10 to the audio device 20 as a designated position indicating the position of the virtual sound source. However, the process is not limited to such a process. The terminal device 10 may calculate a coordinate of the designated position based on the arrangement position of the virtual sound source and the distance to the virtual sound source, and transmit the coordinate to the audio device 20. In other words, information in any format may be transmitted from the terminal device 10 to audio device 20, so long as the designated position can be specified.

According to the above-described processes, the reference of the angle of the loudspeakers SP1 to SP5 is matched with the reference of the angle of the virtual sound source. As a result, specification of the arrangement direction of the virtual sound source can be executed by the same process as that for specifying the arrangement directions of the respective loudspeakers SP1 to SP5. Consequently, because two processes can be commonalized, specification of the position of the loudspeaker and specification of the position of the virtual sound source can be performed by using the same program module. Moreover, because the user uses the common target (in the example, the loudspeaker SP1) as the reference of the angle, the individual target need not be memorized.

<Functional Configuration of the Audio System 1A>

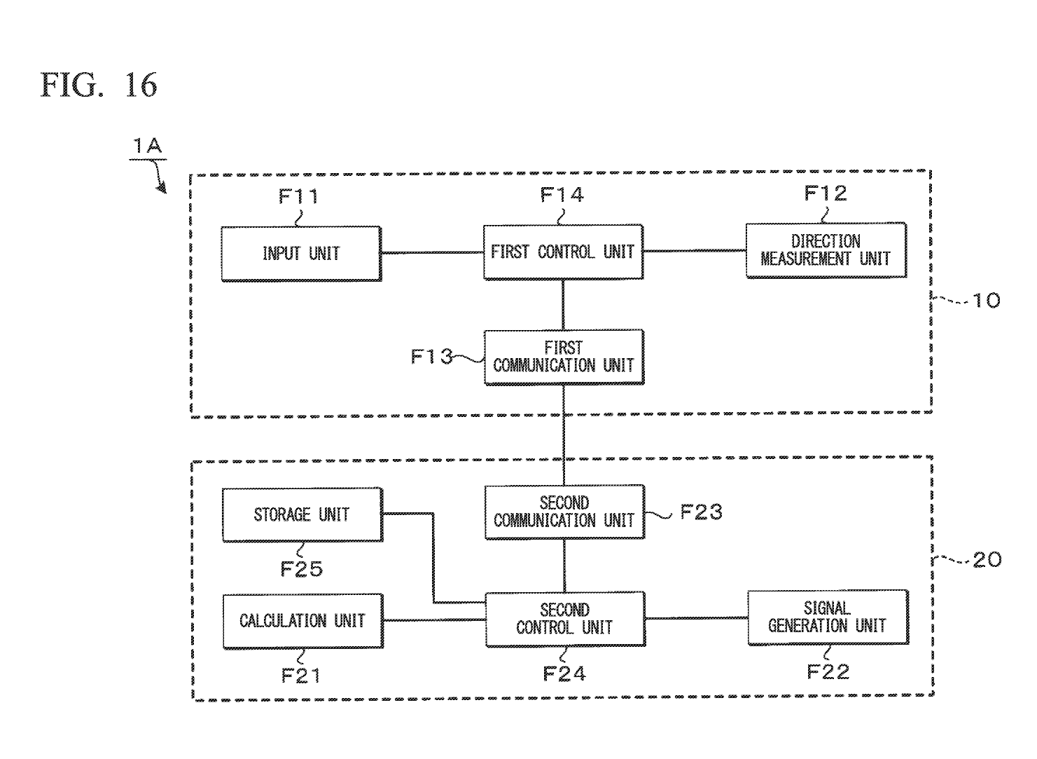

As described above, the audio system 1A includes the terminal device 10 and the audio device 20. The terminal device 10 and the audio device 20 share various types of functions. FIG. 16 shows functions to be shared by the terminal device 10 and the audio device 20 in the audio system 1A.

The terminal device 10 includes an input unit F11, a direction measurement unit F12, a first communication unit F13, and a first control unit F14. The input unit F11 receives an input of an instruction from the user. The direction measurement unit F12 measures the arrangement directions of the respective loudspeakers SP1 to SP5. The first communication unit F13 communicates with the audio device 20. The input unit F11 corresponds to the operating unit 120 described above. The first communication unit F13 corresponds to the communication interface 140 described above. The direction measurement unit F12 corresponds to the gyro sensor 151, the acceleration sensor 152, the orientation sensor 153, and the CPU 100 described above. The first control unit F14 corresponds to the CPU 100. When the user inputs that the terminal device 10 is oriented toward one of the loudspeakers SP1 to SP5 by using the input unit F11, the first control unit F14 controls the direction measurement unit F12 to measure the arrangement direction of the loudspeaker (the above-described step S25). Moreover, the first control unit F14 controls the first communication unit F13 to transmit the arrangement directions of the respective loudspeakers SP1 to SP5 measured by the direction measurement unit F12, to the audio device 20 (the above-described step S27).

The audio device 20 includes a second communication unit F23, a calculation unit F21, a signal generation unit F22, a storage unit F25, and a second control unit F24. The second communication unit F23 communicates with the terminal device 10. The calculation unit F21 calculates the respective positions of the loudspeakers SP1 to SP5 based on the distance from the reference position Pref to the respective loudspeakers SP1 to SP5 and the arrangement directions of the respective loudspeakers SP1 to SP5. The signal generation unit F22 generates the output audio signals OUT1 to OUT5 generated by adding the acoustic effect to the input audio signals for the loudspeakers SP1 to SP5 based on the respective positions of the loudspeakers SP1 to SP5. The storage unit F25 memorizes the distances from the reference position Pref to the respective loudspeakers SP1 to SP5. When the second communication unit F23 receives the arrangement directions of the respective loudspeakers SP1 to SP5, the second control unit F24 supplies the received arrangement directions of the respective loudspeakers SP1 to SP5 to the calculation unit F21, and supplies the distances from the reference position Pref to the respective loudspeakers SP1 to SP5 read from the storage unit F25, to the calculation unit F21.

The second communication unit F23 corresponds to the communication interface 220 described above. The calculation unit F21 and the second control unit F24 correspond to the CPU 210. The signal generation unit F22 corresponds to the CPU 210 and the processing units U1 to Um. The storage unit F25 corresponds to the memory 230.

As described above, according to the present embodiment, the distances from the reference position Pref to the respective loudspeakers SP1 to SP5 are measured beforehand. The arrangement directions of the respective loudspeakers SP1 to SP5 are measured by using the terminal device 10, and the measurement results are transmitted to the audio device 20. By performing the above process, the calculation unit F21 of the audio device 20 can calculate the respective positions of the loudspeakers SP1 to SP5. Then the signal generation unit F22 generates the output audio signals OUT1 to OUT5 added with the acoustic effect, based on the calculated respective positions of the loudspeakers SP1 to SP5. Consequently, even if the loudspeakers SP1 to SP5 are not arranged at the ideal positions, an acoustic effect such as the arrangement and surround effect of the virtual sound source can be realized, considering the actual positions.

### MODIFICATION EXAMPLES

The present invention is not limited to the embodiment described above. Modification examples of the embodiment described above will be described below. The respective modification examples and the embodiment described above can be appropriately combined.

### First Modification Example

In the embodiment described above, the respective positions of the loudspeakers SP1 to SP5 are calculated by the calculation unit F21 provided in the audio device 20. However, the present invention is not limited to such a configuration. The terminal device 10 may calculate the respective positions of the loudspeakers SP1 to SP5.

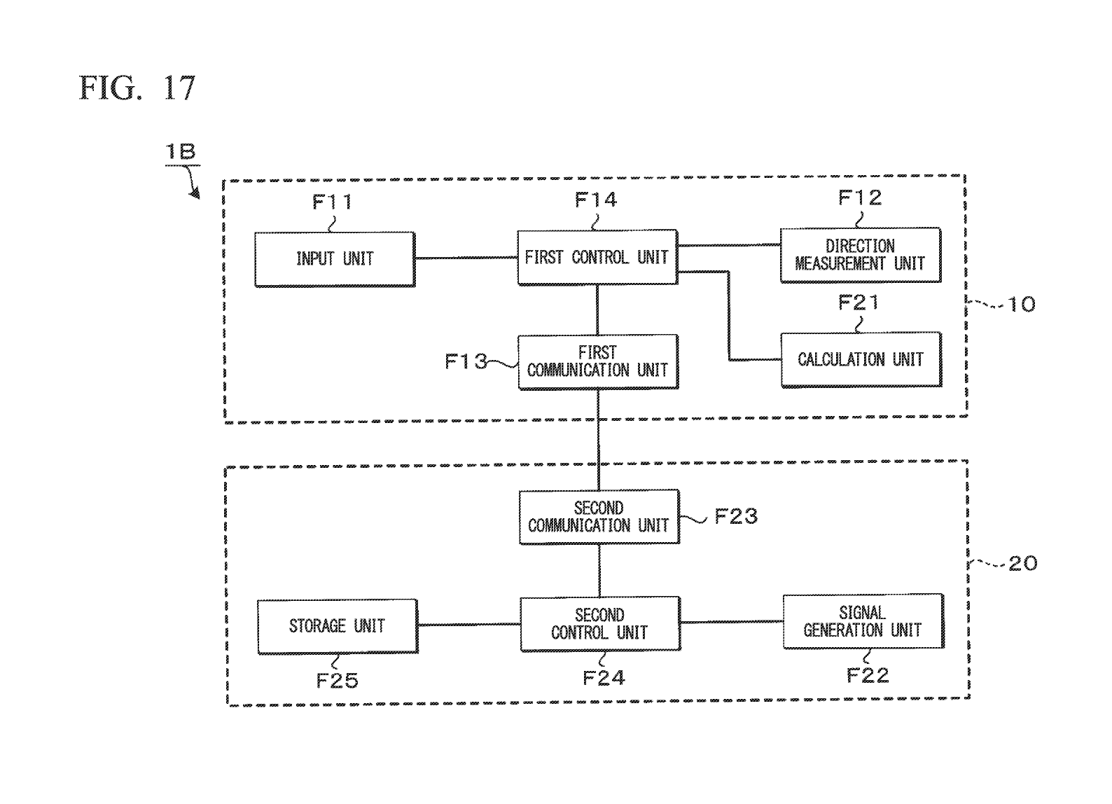

FIG. 17 shows a configuration example of an audio system 1B according to a first modification example. The audio system 1B is configured in the same manner as the audio system 1A shown in FIG. 16, except that the calculation unit F21 is deleted from the audio device 20, and the calculation unit F21 is provided in the terminal device 10.

In the audio device 20 of the audio system 1B, the second control unit F24 controls the second communication unit F23 so as to transmit the distance to each of the loudspeakers SP1 to SP5 read from the storage unit F25, to the terminal device 10. Moreover, the second control unit F24 supplies the respective positions of the loudspeakers SP1 to SP5 received by using the second communication unit F23, to the signal generation unit F22.

In the terminal device 10, when a user A inputs that the terminal device 10 is oriented toward one of the loudspeakers SP1 to SP5 by using the input unit F11, the first control unit F14 controls the direction measurement unit F12 to measure the arrangement direction of the loudspeaker. Moreover, the first control unit F14 controls the calculation unit F21 to calculate the respective positions of the loudspeakers SP1 to SP5, based on the respective directions of the loudspeakers SP1 to SP5 measured by the direction measurement unit F12 and the respective distances of the loudspeakers SP1 to SP5 received by using the first communication unit F13. Furthermore, the first control unit F14 controls the first communication unit F13 so as to transmit the respective positions of the loudspeakers SP1 to SP5 calculated by the calculation unit F21, to the audio device 20. According to the first modification example, the terminal device 10 executes calculation of the respective positions of the loudspeakers SP1 to SP5. As a result, the processing load on the audio device 20 can be reduced. The audio device 20 can memorize the respective positions of the loudspeakers SP1 to SP5 received from the terminal device 10, and can use these positions to add the acoustic effect subsequently.

### Second Modification Example

In the embodiment described above, the respective positions of the loudspeakers SP1 to SP5 are memorized in the storage unit F25 provided in the audio device 20. However, the present invention is not limited to such a configuration. The terminal device 10 may include the storage unit F25. In this case, the terminal device 10 transmits the arrangement directions of the respective loudspeakers SP1 to SP5 measured by the direction measurement unit F12 and the distances of the respective loudspeakers SP1 to SP5 memorized in the storage unit F25, to the audio device 20. Then the calculation unit F21 of the audio device 20 calculates the respective positions of the loudspeakers SP1 to SP5 based on the arrangement directions of the respective loudspeakers SP1 to SP5 and the distances to the respective loudspeakers SP1 to SP5.

The terminal device 10 may include the storage unit F25 and the calculation unit F21. The calculation unit F21 may transmit the calculated respective positions of the loudspeakers SP1 to SP5 to the audio device 20. In this case, the respective positions of the loudspeakers SP1 to SP5 may be memorized in the memory 230 of the audio device 20. Moreover, the output audio signals OUT1 to OUT5 added with the acoustic effect may be generated based on the memorized respective positions of the loudspeakers SP1 to SP5.

### Third Modification Example

In the embodiment described above, measurement of the arrangement directions of the respective loudspeakers SP1 to SP5 is performed at the reference position Pref, when the user A sets the listening position in the listening room to the reference position Pref. However, the present invention is not limited to such a configuration. The arrangement directions of the loudspeakers SP1 to SP5 may be measured at an arbitrary position. In this case, the process described below is performed. That is to say, the terminal device 10 transmits a relative positional relation between the arbitrary position and the reference position to the audio device 20. The calculation unit F21 calculates the respective positions of the loudspeakers SP1 to SP5 based on the relative positional relation, the arrangement directions of the loudspeakers SP1 to SP5 as seen from the arbitrary position, and the distances between the respective loudspeakers SP1 to SP5 and the reference position Pref. More specifically, the calculation unit F21 converts the direction of the relative positional relation of the loudspeakers as seen from the arbitrary position into the directions of the loudspeakers SP1 to SP5 as seen from the reference position Pref, based on the relative positional relation. Moreover, the calculation unit F21 calculates the respective positions of the loudspeakers SP1 to SP5 based on the conversion result and the distances between the respective loudspeakers SP1 to SP5 and the reference position Pref.

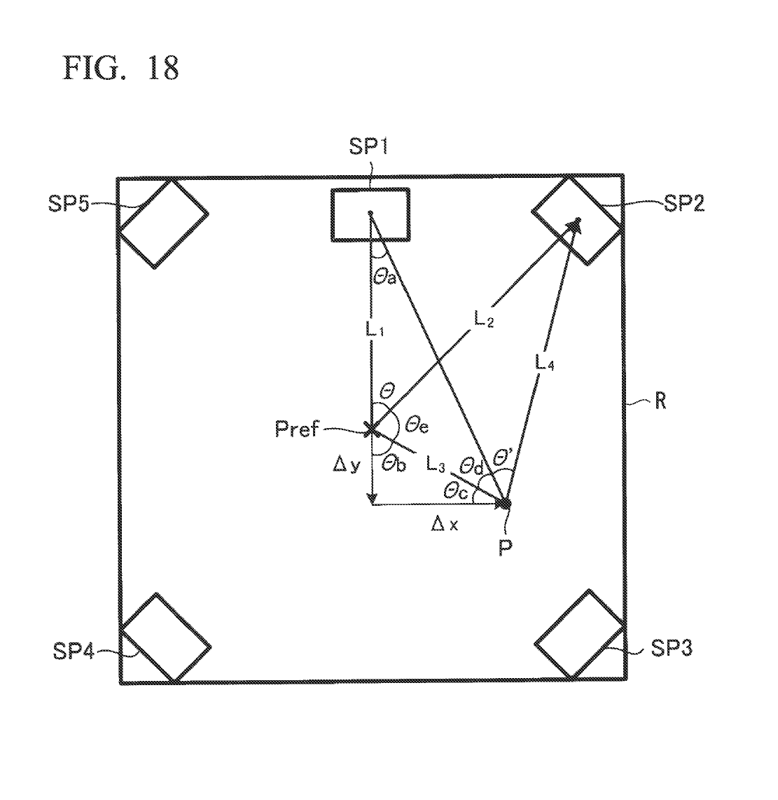

A conversion method for the angle will be described with reference to FIG. 18. An arbitrary position P is set at a position shifted by (Ax, Ay) from the reference position

Pref. A distance from the reference position Pref to the loudspeaker SP1 is set as “L₁”. A distance from the reference position Pref to the loudspeaker SP2 is set as “L₂”. A distance from the reference position Pref to the predetermined position P is set as “L₃”. A distance from the predetermined position P to the loudspeaker SP2 is set as “L₄”. An angle of the loudspeaker SP2 with respect to the loudspeaker SP1 as a reference as seen from the reference position Pref is set as θ. An angle of the loudspeaker SP2 with respect to the loudspeaker SP1 as the reference as seen from the predetermined position P is set as “θ′”. Angles θb, θc, θd, and θe are set as shown in FIG. 18.

“θ”is provided by equation (1) described below. As a result, if “θe” and “θb” can be expressed by a known value, “θ” can be converted to “θ”.

θ=180°−θe−θb Equation (1)

At first, “θa” and “θc” are provided by equations (2) and (3) described below.

θa=a tan(Δx/(L₁+Δy)) Equation (2)

θc=a tan(Δy/Δx) Equation (3)

Moreover, θb=90°−θc. If equation (3) is substituted, equation (4) is acquired.

θb=90°−a tan(Δy/Δx) Equation (4)

Moreover, θb+θc=90°, θa+θd+θc=90°. Therefore, equation (5) can be acquired.

θd=θb−θa Equation (5)

If equation (4) and equation (2) are substituted in equation (5), equation (6) is acquired.

θd=90°−a tan(Δy/Δx)−a tan(Δx/(L₁+Δy)) Equation (6)

Moreover, “L₃” is provided in equation (7) described below. Equation (8) is established for “L₄”.

L₃=(Δx²+Δy²)^{1/2} Equation (7)

L₄²=L₂²+L₃³+2L₂L₃ cxos (θc) Equation (8)

If equation (8) is transformed, “θe” can be expressed by equation (9).

cos(θe)=(L₂²+L₃²−L₄²)/(2L₂L₃)

θe=a cos {(L₂²+L₃²−L₄²)/(2L₂L₃)} Equation (9)

Furthermore, equation (10) is established for “L₄”.

L₂²=L₃²+L₄²−2L₃L₄ cos(θ′+θd) Equation (10)

If equation (10) is solved for “L₄”, equation (11) is established.

L₄={−b±(b²−4c)^{1/2}}/2 Equation (11)

where b=−2L₃cos(θ′+θd), c=L₃²−L₂².

Here, a positive value is selected as “L₄”.

In equation (11), “θ′” and “L₂” are known. “L₃” is also known from equation (7). “θd” is also known from equation (6). As a result, if equation (6) and equation (7) are substituted in equation (11), “L₄” can be acquired. Moreover, if “L₄” calculated by equation (11), “L₃” calculated by equation (7), and the known “L₂” are substituted in equation (9), “θe” can be calculated. By substituting “θe” and “θb” calculated by equation (4) in equation (1), “θ” can be acquired.

“Δx” and “Δy” are relative coordinates from the predetermined position P to the reference position Pref. Therefore, “Δx” and “Δy” can be acquired by using an integration result of the output signal of the triaxial acceleration sensor 152 of the terminal device 10 and the output signal of the orientation sensor 153. Specifically, it is required that integration is started when the user inputs a start instruction by using the operating unit 120 at the arbitrary position P, and integration is finished when the user inputs an end instruction by using the operating unit 120 after the user has moved to the reference position Pref. Alternatively, the user may input “Δx” and “Δy” by using the operating unit 120.

### Fourth Modification Example

In the embodiment described above, in the measurement of the arrangement directions of the respective loudspeakers SP1 to SP5, the direction measurement unit F12 sets the loudspeaker SP1 as the reference, and outputs the angle with respect to the reference, as the direction. However, the present invention is not limited to such a configuration. An arbitrary target arranged in the listening room may be set as the reference, and the angle with respect to the reference may be measured as the direction.

For example, in the case where a television is arranged in the listening room, the direction measurement unit F12 may set the television as a target and output the angle with respect to the television (target) as the reference, as the direction. In this case, if the user inputs that the terminal device 10 is oriented toward the television, which serves as the target being the reference, by using the input unit F11, the first control unit F14 controls the direction measurement unit F12 so as to set the angle being the reference. Then if the user operates the input unit F11 in a state with the terminal device 10 oriented toward each of the loudspeakers SP1 to SP5, the first control unit F14 controls the direction measurement unit F12 so as to measure the direction of that loudspeaker.

### Fifth Modification Example

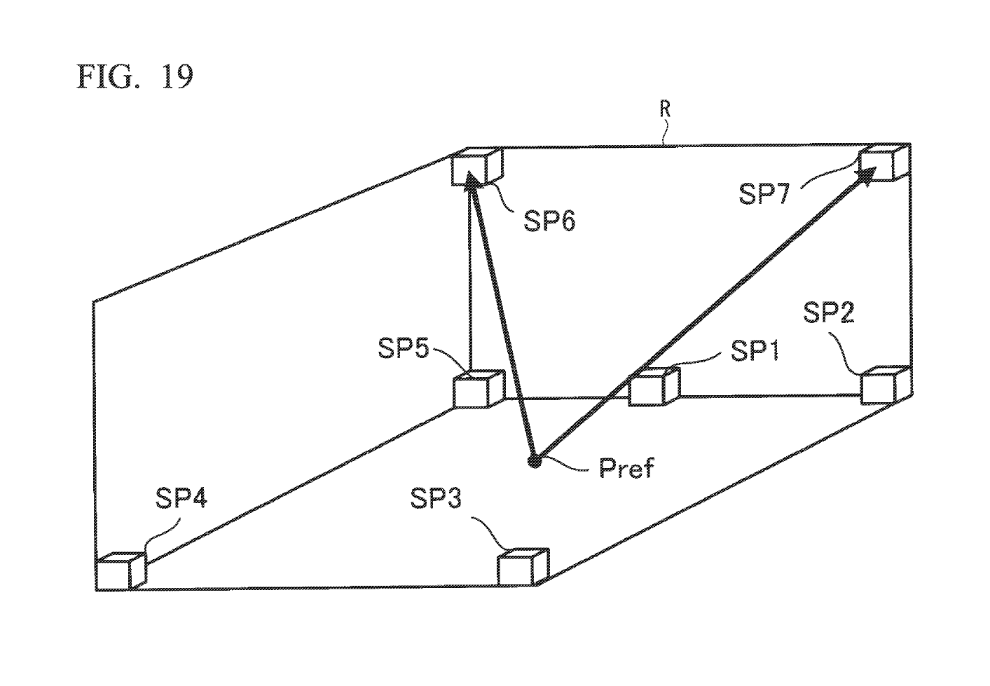

In the embodiment described above, the case where the loudspeakers SP1 to SP5 are arranged two-dimensionally has been described. However, as shown in FIG. 19, the loudspeakers SP1 to SP5 may be arranged three-dimensionally. In this example, a loudspeaker SP6 is arranged diagonally upward forward left as seen from the reference position Pref. A loudspeaker SP6 is arranged diagonally upward forward right. Thus, even if the loudspeakers SP1 to SP7 are arranged three-dimensionally in this way, the arrangement directions of the respective loudspeakers SP1 to SP7 may be measured by using the angle of the respective loudspeakers SP2 to SP7 with the loudspeaker SP1 as the reference.

According to the embodiment described above, the information indicating the arrangement directions of the loudspeakers measured by the terminal device is transmitted to the audio device. Consequently, when the distance to the loudspeaker is known, even if the position of the loudspeaker deviates from the ideal position, the audio device can calculate the actual positions of the plurality of loudspeakers, and can add the desired acoustic effect thereto. Moreover, in the measurement of the direction, the user only needs to operate the input unit by orienting the terminal device toward the target loudspeaker, thereby enabling to measure the arrangement direction of the loudspeaker easily.

According to the first modification example of the above embodiment, the distance to the loudspeaker is transmitted from the audio device to the terminal device. The terminal device calculates the position of the loudspeaker based on the measured arrangement direction of the loudspeaker and the received distance. As a result, the audio device need not include the calculation unit, and hence, the configuration of the audio device can be simplified.

According to the above embodiment, when the acceleration sensor and the gyro sensor that detect the relative direction are used as the direction measurement unit, the target can be set as the reference. Consequently, the angle formed by the arrangement direction of the target and the arrangement direction of the loudspeaker can be acquired.

According to the embodiment described above, when the designation direction in which the virtual sound source is positioned is input by using the terminal device, the designation direction is input by using a target the same as the target which has been used as a reference in the measurement of the arrangement direction of the loudspeaker, as the reference. Accordingly, the angle of the virtual sound source with respect to the reference can be treated as the angle of the loudspeaker with respect to the reference. As a result, the arrangement process of the virtual sound source in the signal generation unit can be simplified. Moreover, a relative angle error between the loudspeaker and the virtual sound source can be reduced by setting the same target as the reference.

According to the embodiment described above, time and labor to input the reference can be simplified by setting a predetermined loudspeaker as the target.

The order of designating the arrangement direction of the loudspeaker by the user by using the input unit may be preset. Moreover, the target may be a loudspeaker to be designated first, of the plurality of loudspeakers. In this case, the information indicating the arrangement directions of the second loudspeaker and thereafter is provided as the angles with respect to the first loudspeaker as the reference. Furthermore, the predetermined loudspeaker may be a loudspeaker in an arbitrary order. In this case, it is appropriate to subtract the angle of the predetermined loudspeaker from the angle of other loudspeakers to specify the arrangement directions of the plurality of loudspeakers.

### INDUSTRIAL APPLICABILITY

The present invention is applicable to audio devices, audio systems, and methods.

### REFERENCE SYMBOLS

1A, 1B Audio system
10 Terminal device
20 Audio device
F11 Input unit
F12 Direction measurement unit
F13 First communication unit
F14 First control unit
F21 Calculation unit
F22 Signal generation unit
F23 Second communication unit
F24 Second control unit
F25 Storage unit

1. An audio device comprising:
an acquisition unit that acquires first information indicating an arrangement direction of a first loudspeaker, the first information being measured by a terminal device in a state with the terminal device oriented toward the first loudspeaker; and
a calculation unit that calculates a position of the first loudspeaker, at least based on a distance from a reference position to the first loudspeaker, and the first information.

2. An audio system comprising:
a direction measurement unit that measures first information indicating an arrangement direction of a first loudspeaker in a state with a terminal device oriented toward the first loudspeaker; and
a calculation unit that calculates a position of the first loudspeaker, at least based on a distance from a reference position to the first loudspeaker, and the first information.

3. The audio system according to claim 2, further comprising the terminal device and an audio device, wherein
the terminal device includes:
the direction measurement unit;
an input unit that receives an input of an instruction from a user;
a first communication unit that communicates with the audio device; and
a first control unit that causes the direction measurement unit to measure the first information when the input unit receives the input from the user in a state with the terminal device oriented toward the first loudspeaker, the first control unit causing the first communication unit to transmit the first information to the audio device, and
the audio device includes:
the calculation unit;
a second communication unit that communicates with the terminal device; and
a second control unit that supplies the first information to the calculation unit when the second communication unit receives the first information.

4. The audio system according to claim 2, further comprising the terminal device and an audio device, wherein
the terminal device includes:
the direction measurement unit;
the calculation unit;
an input unit that receives an input of an instruction from a user;
a first communication unit that communicates with the audio device; and
a first control unit that causes the direction measurement unit to measure the first information when the input unit receives the input from the user in a state with the terminal device oriented toward the first loudspeaker, the first control unit causing the calculation unit to calculate a position of the first loudspeaker, the first control unit causing the first communication unit to transmit the first information to the audio device, and
the audio device includes:
a storage unit that memorizes a distance to the first loudspeaker;
a second communication unit that communicates with the terminal device; and
a second control unit that causes the second communication unit to transmit, to the terminal device, the distance to the first loudspeaker read from the storage unit, the second communication unit supplying the position of the first loudspeaker received by the second communication unit, to a signal generation unit.

5. The audio system according to claim 3, wherein
the direction measurement unit measures second information indicating an arrangement direction of a target in a state with the terminal device oriented toward the target, and
the first control unit sets the arrangement direction of the target as a reference.

6. The audio system according to claim 5, wherein the direction measurement unit measures an angle formed between the arrangement direction of the target and the arrangement direction of the first loudspeaker, as the first information.

7. The audio system according to claim 5, wherein
the target is a second loudspeaker different from the first loudspeaker, and
the first control unit causes the direction measurement unit to measure an angle formed between an arrangement direction of the second loudspeaker and an arrangement direction of the first loudspeaker, as the first information.

8. The audio system according to claim 5, wherein the first control unit causes the direction measurement unit to measure an angle formed between the arrangement direction of the target and the arrangement direction of a virtual sound source when the input unit receives an input in a state with the terminal device oriented toward the arrangement direction of the virtual sound source.

9. The audio system according to claim 5, wherein
the audio device further includes a signal generation unit,
the signal generation unit generates an output audio signal that sounds as if sound is coming from a designated position determined from a designation direction being an arrangement direction of a virtual sound source and a distance to the virtual sound source, at least based on the position of the first loudspeaker,
the first control unit causes the direction measurement unit to measure an angle formed between the arrangement direction of the target and the designation direction when the input unit receives the input from the user in a state with the terminal device oriented toward the designation direction,
the first control unit causes the first communication unit to transmit the designated position to the audio device, and
the second control unit supplies the designated position to the signal generation unit when the second communication unit receives the designated position.

10. A method for an audio system, comprising:
measuring first information indicating an arrangement direction of a first loudspeaker in a state with a terminal device oriented toward the first loudspeaker; and
calculating a position of the first loudspeaker, at least based on a distance from a reference position to the first loudspeaker, and the first information.
